(19) United States
(12) Patent Application Publication
(10) Pub. No.: US 2022/0159359 A1
(43) Pub. Date: May 19, 2022

(54) SPEAKER COMBINED WITH LIGHTING APPARATUS

(71) Applicant: RNS CO.,LTD, Bucheon-si, Gyeonggi-do (KR)

(72) Inventor: Jun Sung KIM, Seoul (KR)

(73) Assignee: RNS CO.,LTD, Bucheon-si, Gyeonggi-do (KR)

(21) Appl. No.: 17/297,991

(22) PCT Filed: Nov. 28, 2018
(86) PCT No.: PCT/KR2018/014762

§ 371 Date: Jan. 24, 2022

(51) Int. Cl. H04R 1/02; F21V 33/00; F21V 21/15; F21V 23/06; F21V 21/30

(52) U.S. Cl. CPC H04R 1/028; F21V 33/0056; F21V 21/30; F21V 23/06; F21V 21/15

(57) ABSTRACT

The present invention relates to speaker combine with lighting devices.

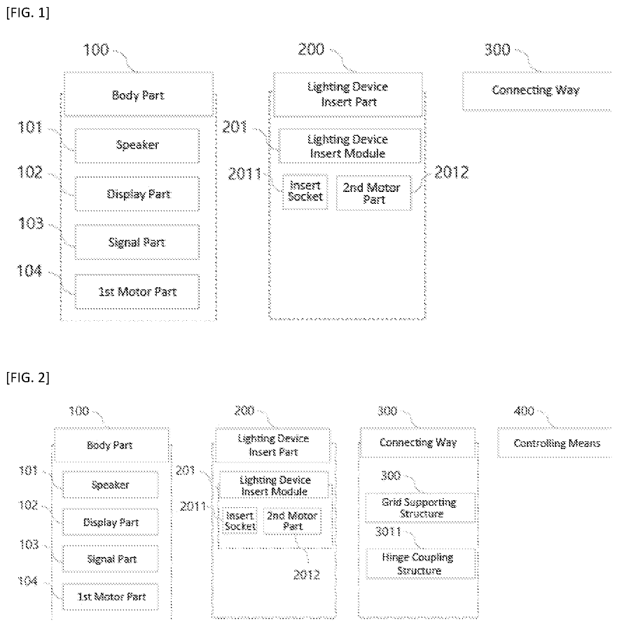

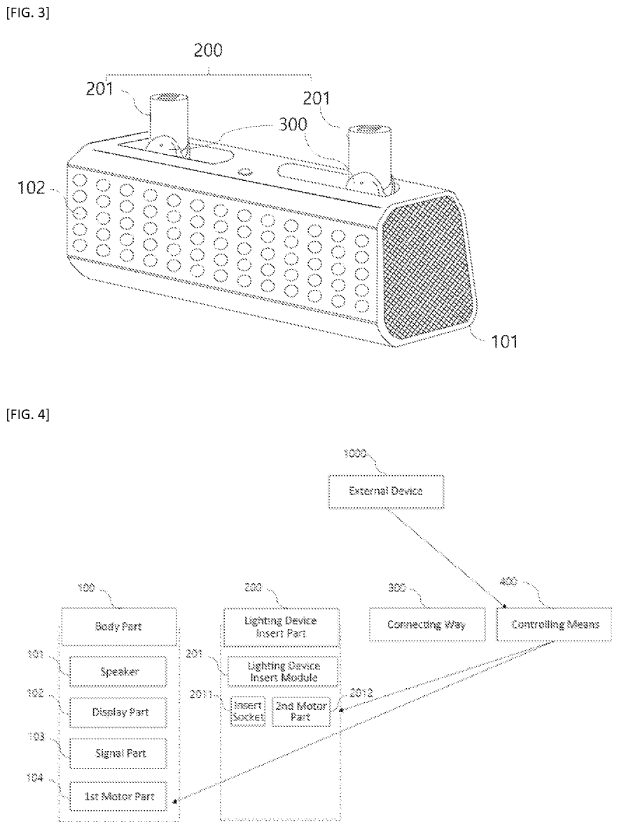

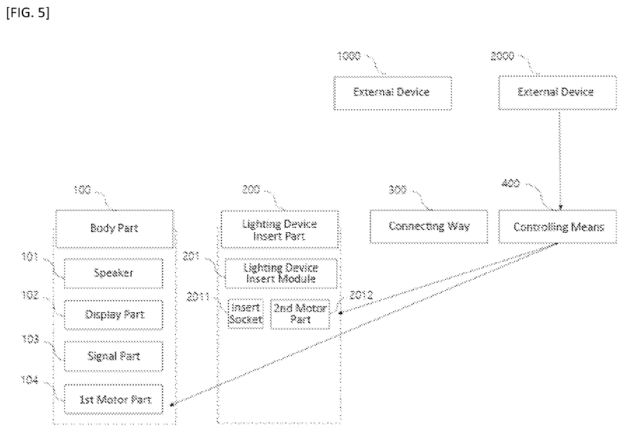

According to the present invention lighting device combine speaker is not only connected to an external device to play the sound source through the speaker, but also device that can double as lighting device, and can encourage atmosphere in an event hall, a party, a club, or the like.

### TECHNICAL FIELD

The present invention refers to a combination product that include both a lighting device and a speaker.

More specifically, this present invention is connected to an external device, playing the sound source through the speaker and controlling the operation of the lighting device based on the sound source from the external device mentioned above. It also controls the operation of the light device based on the user's motion information provided from the external device with the motion sensor as the above or other external device.

### BACKGROUND OF THE INVENTION

Recently the development of digital technology and mobile communication technology have allowed users to carry and use digital devices including smart phone, tablet and laptop regardless of places. These digital devices basically have the function to play music files.

Music files reproduced through digital devices are provided to users by speaker or headset that receives and outputs through Bluetooth wireless communication. Especially, Bluetooth speaker has the advantage to allow users to listen music at desired places by carrying it, so many users use it for outdoor music listening.

Meanwhile, in event venues, various parties and clubs, lighting devices have been used to enhance the atmosphere of the place along with sound sources provided by Bluetooth speakers. But most of lighting devices have been designed for saving energy and dissipating heat technically, which means there is still insufficient development of technology for multifunctional speakers designed to enhance the atmosphere of the place in harmony with the Bluetooth speaker.
(Patent Literature 1) Patent Registration Notification No. 275891(2013.6.11)
(Patent Literature 2) Patent Registration Notification No. 143941842014.9.2)
(Patent Literature 3) Patent Registration Notification No. 1439418(2014.9.2)
(Patent Literature 4) Public Patent Notification No. 1439418(2014.9.2)

### DETAILED DESCRIPTION OF THE INVENTION

### Technical Objectives that the Invention Intends to Achieve

With the present invention, a sound source provided from the external device is reproduced through the speaker. It also provides that speaker with the lighting device that is effective in inspiring an atmosphere in an event hall or various parties and clubs with the operation of the lighting device corresponding to the sound source.

Since the present invention is designed to attach and detach various lighting devices, it provides the combination light and sound producing speaker that can more effectively create a user's desired atmosphere.

Furthermore, the present invention can adjust the operation of the light device based on the user's motion information provided from the external device including a motion sensor as the above or other external device. It finally provides the combination light and sound producing speaker to effectively inspire the atmosphere at a desired place.

Methods to be Solved by the Invention

The present invention refers the combination light and sound producing speaker. The present invention is developed to solve the above problems.

The combination light and sound producing speaker is comprised of the main body, lighting device insertion unit located at the top of the main body to include at least one insertion module which is designed to insert lighting devices, the connection unit connecting the main body and the insertion part. In addition, the main body contains speaker that outputs sound source provided from external device, display with built-in multiple light sources, communication unit that performs wired/wireless communication with external devices and the 1st motor unit that provides power for left and right or up and down rotation of the lighting device. The insertion part is composed of Insert socket designed to insert lighting devices and the 2nd motor unit that provides power for left and right or up and down rotation of the lighting device.

The lighting device insertion part includes a pair of lighting device insertion modules, which has at least one USB type insertion structure.

The connection unit can contain a flexible tube.

The connection unit can contain the supporting structure with a capable of supporting and fixing the lighting device insertion module of the lighting device insertion part.

The supporting structure can contain a hinge coupling structure. It supports and fixes the lighting device so that the lighting device can rotate up and down or left and right by the power of the second motor part of the lighting device insertion module.

The combination light and sound producing speaker

The control unit can control general mode, lighting mode, sound source reproduction pattern mode, warning lamp mode, synchronization mode, or mixer mode according to a control signal from the external device transmitted through the communication unit.

The control unit can control the operation of the 1st and 2nd motor units based on the sound source transmitted through the communication unit. It can also control both of motor units according to the user's motion information provided from the external device including a motion sensor as the above or other external device.

### Effects of the Invention

The present invention enables a sound source provided from the external device to be reproduced through a speaker. It is also effective in inspiring the atmosphere in various parties and club by providing an operation of the lighting device corresponding to a corresponding sound source.

The present invention is designed to attach and detach various lighting devices, which can enable users to create the desired atmosphere more effectively.

Furthermore, the present invention is very effective in providing dynamics according to the sound source by providing the operation of the light device based on the user's motion information provided from the external device including a motion sensor as the above or other external device.

The effect of this invention is not limited to the above-mentioned range.

### BRIEF EXPLANATION OF THE DRAWINGS

Drawing 1 and 2 is block drawing for explaining in more detail each configuration of that combination speaker according to the present invention.

Drawing 3 is perspective drawing of the combination speaker.

Drawing 4 is block drawing for explaining how the combination speaker controls the movement of the lighting device through interaction with the external device.

### TECHNICAL FIELD OF THE INVENTION AND PRIOR ART

The present invention will be described in more detail.

In patent specification, if not specified, singular expressions include plural expressions.

As for the terms used, a general term that is currently widely used as possible has been selected while considering the functions in the present invention. But the terms can vary depending on the intention of the technician in the field or the emergence of new technologies. In certain cases, there are terms arbitrarily selected by the applicant. In this respect, the meaning will be described in detail in the description of the present invention. The terms used in the present invention should be defined based on the meaning of the term and the features described in this specification, not a simple name of the term.

In the specification. In this specification, terms such as “comprise” or “constitute” are intended to designate the existence of features, numbers, steps, actions, components, parts, or a combination thereof described in the specification. It is to be understood that the above other features or the possibility of the presence or addition of numbers, steps, actions, components, parts, or combinations thereof are not preliminarily excluded

The present invention refers to the combination product that include both a lighting device and a speaker.

The combination light and sound producing speaker according to the present invention performs the function of allowing a sound source provided from the external device to be played through the speaker. With the lighting device placed at the top, It can enhance the atmosphere in various parties and club by providing an operation of the lighting device corresponding to a corresponding sound source.

The speaker according to the present invention is designed in order that the lighting device can be replaced according to the genre or atmosphere of the sound source. In this respect, users can more effectively implement the desired atmosphere.

The speaker according to the present invention is very effective in providing dynamics according to the sound source by providing the operation of the light device based on the user's motion information provided from the external device including a motion sensor as the above or other external device.

Drawing 1 is block drawing for explaining each configuration of the speaker r in more detail.

The combination light and sound producing speaker is comprised of the main body (100), the lighting device insertion unit (200) located at the top of the main body to include at least one insertion module (201) which is designed to insert lighting devices, the connection unit (300) linking the main body and the insertion part. In addition, the main body contains speaker (101) that outputs sound source provided from external device, display (102) with built-in multiple light sources, communication unit (103) that performs wired/wireless communication with external devices and the 1st motor unit (104) that provides power for left and right or up and down rotation of the lighting device. The insertion part is composed of the insert socket (2011) designed to insert lighting devices and the 2nd motor unit (2012) that provides power for left and right or up and down rotation of the lighting device.

The combination light and sound producing speaker contains the main body (100)

The main body (100) includes speaker (101) that outputs sound source provided from external device, display (102) with built-in multiple light sources, communication unit (103) that performs wired/wireless communication with external devices and the 1st motor unit (104) that provides power for left and right or up and down rotation of the lighting device.

Speaker (101) plays a role in outputting sound source provided from external device. Specifically, it plays the role of outputting the sound source provided by wired or wireless method from the external device through the communication unit.

The amount of output of the speaker (101) is not particularly limited and may have the amount of output that general speakers (101) have. For example, it may have an output amount in the range of 2 W to 20 W, but is not limited thereto.

The speaker (101) may be located in front, rear, front and rear, one side or both sides of the main body. The output amount of the speaker (101) located in one part of the main body may be the same as or different from that of a speaker located in another part

The display unit (102) includes a plurality of light sources. That light sources can be LED lighting, for example.

The plurality of light sources may be formed on the display unit (102) at uniform intervals. If these light sources achieve the purpose of evenly illuminating the entire surface of the display unit (102), the size or number of these multiple sources would have no particular limitation.

The display unit (102) can control the type or genre of sound source provided from external devices and the intensity of the light source, whether the light source blinks, and the blinking interval of the light source according to the operation of the control unit based on the user's mode adjustment provided from external devices

The display unit (102) may provide the user with a figure pattern corresponding to any one theme selected by the user, for example, one theme selected from the group of Equalize, Groove, Rainbow, Moo, Trot, Club, Ballad, Classic, Elec and Celebration.

In addition, the display unit (102) may provide the user with a character pattern provided from external devices.

For example, when a user enters a character through a specific application of external devices, the character is transmitted through the communication unit (103) of the main body (100). The display unit (102) can provide a predetermined character pattern to the user by the operation of the control unit (400).

The communication unit (103) that performs wired/wireless communication with external devices performs the function to receive a sound source provided from external devices via wired or wireless communication, and outputting the sound source to the speaker of the main body (100) under the operation of the control unit (400).

In one sample, the communication unit (103) can include a Bluetooth module, a ZigBee communication module, and a Wi-Fi communication module or a wireless communication module such as an NFC communication module. It (103) also desirably includes the Bluetooth module

In another example, the communication unit (103) includes AUX cable terminal, an RCA cable terminal, or sound source receiving terminal such as BNC cable terminal. It also receives sound source provided from external devices by wire.

Through the wireless communication module or sound source receiving terminal abovementioned, the speaker can output a sound source provided from external devices through the speaker (101) of the main body (100) through the control unit (400).

The main body (100) of the combination speaker according to the present invention includes the 1st motor unit (104) to provide power for left and right or up and down rotation of the lighting device that can be attached to the top.

In other words, the 1st motor unit (104) provides power to the connection unit (300) connecting the main body and the lighting device insertion unit (200). It enables the lighting device to select one of left and right rotation and up and down rotation. Meanwhile, the direction of providing rotational power of the 1st motor unit can be set in connection with the 2nd motor unit (2012).

In one example, in case that the 2nd motor unit (2012) provides the power for left and right rotation to the lighting device, the 1st motor unit (104) may provide power to rotate the lighting device up and down through the connection unit (300) connecting the main body and the lighting device insertion unit (200).

In another example, when the 2nd motor unit (2012) provides vertical rotation power to the lighting device, the 1st motor unit (104) may provide power to rotate the lighting device up and down through the connection unit (300) connecting the main body and the lighting device insertion unit (200).

The power for left and right or up and down rotation of 1st and 2nd motor units abovementioned can be performed through the control operation of the control unit (400), such as genre or type of sound source provided through the external device and/or the user's motion information provided from the external device with motion sensor as the above or other external device.

The combination light and sound producing speaker according to the present invention includes the lighting device insertion unit (200) located at the top of the main body to include at least one insertion module (201) which is designed to insert lighting devices

The insertion module (201) located at the top of the main body (100) is designed to insert lighting devices. The module (201) is composed of Insert socket (2011) designed to insert lighting devices and the 2nd motor unit (2012) that provides power for left and right or up and down rotation of the lighting device.

The structure or shape of the insert socket (2011) is not particularly limited as long as it can be inserted into lighting devices.

In one example, the insert socket (2011) can have a USB type insertion structure.

In other words, the lighting device insertion unit (200) may include lighting devices which can supply power by inserting USB type structure. Accordingly, when the lighting device has the USB type insertion structure, the type of that device is not particularly limited, to the extend that mood lamps, mirror balls, or stands that can have various structures, shapes, and intensity of a light source.

The insert socket (2011) can have at least one USB type insertion structure. For example, it (2011) can have 1, 2, 3, 4 or 5 USB insertion structures, but is not limited thereto.

The insertion module (201) additionally includes the 2nd motor unit (2012) that provides power for left and right or up and down rotation of the lighting device.

In one example, the 2nd motor unit (2012) provides power to the insert socket (2011) so that the lighting device can select either up/down or left/right rotation. Meanwhile, The direction of providing rotational power of the 2nd motor unit (2012) can be set in conjunction with the 1st motor unit (104).

In one example, when the 1st motor unit (104) provides the power of left and right rotation to the lighting device, the 2nd motor unit (2012) can supply power for that device coupled to the insert socket (2011) to turn up and down.

In another example, when the 1st motor unit (104) provides vertical rotation power to the lighting device, the 2nd motor unit (2012) can supply power for that device coupled to the insert socket (2011) to turn right and left.

The 2nd motor unit (2012) is located at a certain position inside the lighting device insertion module, providing power for left and right or up and down rotation of the lighting device mentioned above.

Like the 1st motor unit, up/down or left/right rotation motion of the 2nd motor unit. TBD

For example, the insertion module (201) can be consisted of one or more lighting device insertion unit (200).

In one example, the lighting device insertion unit (200) can contain a pair of the insertion module (201), as seen in the perspective drawing of the combination light and sound producing speaker according to this invention shown in drawing 3. In this case, a pair of insert sockets (2011) can be characterized in having at least one USB type insertion structure.

Since the combination light and sound producing speaker according to the present invention contains a certain USB type of insertion structure, at least one insertion module (201) which is designed to combine with various lighting devices, the 1st motor unit (104) that provides power for left and right or up and down rotation of the lighting device, the 2nd motor unit (2012) that provides power for left and right or up and down rotation of the lighting device and the 1st and 2nd motor units that can be performed through the sound source transmitted from the communication unit and through the user's motion information provided from the external device including a motion sensor as the above or other external device, it is very effective to inspire an atmosphere in an event hall or various parties and clubs.

The combination light and sound producing speaker according to the present invention includes the main body (100), the lighting device insertion unit (200) and the connection unit (300) linking the main body and the insertion part.

The connection unit (300) plays a role in connecting the main body that outputs sound source and the lighting device insertion unit (200) with the lighting device that rotates left/right and/or up/down.

More specifically, the connection unit (300) plays a role in connecting the main body (100) and the insert module (201) in order that up/down or left/right rotation power of the 1st motor unit (104) is provided to the light device coupled to the insertion module (201) of the lighting device insertion unit (200).

When the connection unit (300) can achieve objectives mentioned above, it can be of various shapes and types.

In one example, the connection unit (300) can include flexible tube. If that, users can adjust the direction and intensity of the light source in the desired direction by changing the position of the light device in person.

In another example, the connection unit (300) can contain the supporting structure (301), one with a capable of supporting and fixing the insertion module (201) of the lighting device insertion part (200), as shown in block drawing of the combination light and sound producing speaker according to this invention shown in drawing 2.

The supporting structure (301), for example, can have the form “C” with having the insert module (201) inside. In this case, this structure (301) can contain the hinge coupling structure (3011). That structure (3011) supports and fixes the lighting device so that the lighting device can rotate up and down or left and right by the power of the 2nd motor unit (2012) of the lighting device insertion module (201). Though the hinge structure (3011), the up/down or left/right rotation power of the 2nd motor unit (2012) can be delivered to the lighting device insertion module (201), ultimately turning the light device combined with the insert socket (2011).

More specifically, the hinge coupling structure (3011) is located at both ends within the “c” shape of the supporting structure (301), delivering the up/down rotation power of the 2nd motor unit (2012) to the lighting device insertion module (201). In another example, the hinge structure is located at any one end in the “c” shape of the support structure, delivering the left/right rotation power of the 2nd motor unit (2012) to the lighting device insertion module (201).

When using the connection unit (300) abovementioned, the movement of the light device can be effectively controlled according to the sound source transmitted through the communication unit and according to the user's motion information provided from the external device including a motion sensor as the above or other external device.

The combination light and sound producing speaker includes functions mentioned above and the control unit (400) that controls the operation of the whole device and interaction with external devices.

In one example, the control unit (400) controls the playback mode according to a control signal from an external device transmitted through the communication unit (103), the operation of the light device in order that the intensity of the light device and the interval of that device can be adjusted according to the sound source transmitted through the external device, the display unit in order that the intensity of the light source, whether the light source blinks, and the blinking interval of the light source can be adjusted according to the sound source provided from external devices through the external device.

The control unit (400) can control the playback mode based on signal of the playback mode set by the user through the specific application.

In one example, the control unit (400) can control normal mode, lighting mode, sound source playback pattern mode, warning light mode, synchronization mode or mixing mode based on the control signal provided through the communication unit (103).

The normal mode mentioned can control the operation of the light device to adjust output power transmitted through the external device, intensity of lighting and lighting interval. That mode can also control the display unit to adjust the intensity of the light source, whether the light source blinks, and the blinking interval of the light source.

The lighting mode mentioned can control the light device and on/off function of the display unit based on the control signal of the user provided through the external device.

The sound source playback pattern mode mentioned can control the display unit to provide, for example, one theme selected from the group of Equalize, Groove, Rainbow, Moo, Trot, Club, Ballad, Classic, Elec and Celebration selected by the user.

The warning light mode mentioned can control the display unit to provide a character pattern through a plurality of light sources in the main body. It can also control on/off function of the light device corresponding to the operation of the display unit above.

The synchronization mode mentioned can play a role of multiple combination speaker pairing, controlling them as a single device, when there are multiple speakers.

The mixing mode mentioned means a mode that mixing sound like sound effect and special sound is output to the speaker along with the sound source based on the control signal through the external device.

In addition, the control unit (400) can control the operation of the light device to adjust the intensity of the lighting and lighting interval based on the sound source transmitted through the external device provided through the communication unit (103). It can also control the display unit to adjust the intensity of the light source, whether the light source blinks, and the blinking interval of the light source based on the sound source transmitted through the external device provided through the communication unit (103).

The intensity of the lighting and lighting interval based on the sound source abovementioned can be performed, for example, based on setting values for operation of other lighting according to the sound source stored in the memory unit descried later.

In a more specific example, the intensity of the lighting and lighting interval based on the sound source can be controlled based on setting values for operation of other lighting according to the sound source including the type or genre of sound source stored in the memory unit descried later.

The intensity of the light source, whether the light source blinks, and the blinking interval of the light source can also be controlled based setting values for operation of the lighting according to the sound source stored in the memory unit descried later.

In a more specific example, the intensity of the light source, whether the light source blinks, and the blinking interval of the light source can be controlled based on setting values for operation of other lighting according to the sound source including the type or genre of sound source stored in the memory unit descried later.

In addition, the control unit (400) can control the operation of 1st and 2nd motor units based on the sound source transmitted from the communication unit (103) and based on the user's motion information provided from the external device with motion sensor as the above or other external device.

In a more specific example, according to drawing 4, the control unit (400), as the external device (1000) to produce the sound source, can control the 1st and 2nd motor units' operation based on the user's motion provided through that device (1000) with motion sensor.

In another example, according to drawing 5, the control unit (400) which works as different external device from the device (1000), can control the 1st and 2nd motor units' operation based on the user's motion provided through that external device (2000) with motion sensor. In this case, that external device (2000) includes portable devices with motion sensor such as smart-phone, bracelet, smart watch, baton or cheering rod.

The type of motion sensors mentioned above is not particularly limited, if they are capable to detect the motion of the user. For example, they can include at least any one device with kind of sensors such as gyro sensor, acceleration sensor, angular acceleration sensor, and inclination sensor.

The combination light and sound producing speaker can also contain the memory unit additionally.

The memory unit abovementioned can store setting values for operation of the light device and/or display unit according to the sound source transmitted through the external device. Therefore, based on that setting values in memory unit, the control unit (400) can control operation of the light device and/or the display unit.

In one example, the memory unit abovementioned can store setting values for operation of the light device and/or display unit according to genre or type of the sound source transmitted through the external device.

In addition, the memory unit abovementioned can store setting values for operation of the light device and/or display unit according to various playback modes.

In one example, the memory unit abovementioned can store setting values for operation of the light device and/or display unit according to normal mode, lighting mode, sound source playback pattern mode, warning light mode, synchronization mode or mixing mode.

Furthermore, the memory unit abovementioned can save data about the operation value of the 1st and 2nd motor units based on the user's motion information provided from the external device (1000) or the different external device (2000). This operation value can be referred from speed and angle of the 1st and 2nd motor units which correspond to the information about user's motion.

In this respect, with setting values for operation of the light device and display unit according to genre or type of the sound source and the control of the light device followed up that, the combination light and sound producing speaker can create an appropriate atmosphere for the sound source provided through the external device and control operation of the light device based on the user's motion information, ultimately providing dynamics according to the sound source in a specific place.

Drawing 3 shows the perspective drawing on the combination light and sound producing speaker.

According to drawing 3, the combination light and sound producing speaker is comprised of the main body (100), the lighting device insertion unit (200) located at the top of the main body to include at least one insertion module (201) which is designed to insert lighting devices, the connection unit (300) linking the main body and the insertion part. In addition, the lighting device insertion unit (200) contains a pair of the insertion module (201). A pair of insert sockets (2011) can be characterized in having at least one USB type insertion structure. The connection unit (300) can contain the supporting structure (301) with a capable of supporting and fixing the lighting device insertion module (201) of the lighting device insertion unit (200). That structure (301) can have hinge coupling structure that supports and fixes the lighting device so that the lighting device can rotate up and down or left and right by the power of the 2nd motor unit (2012) of the lighting device insertion module.

Although not shown in the drawing 3, the combination speaker has that structure as shown in drawing 3 with additionally the control unit (400) and the memory unit, controlling operation of the lighting and display units based on genre and type of sound source provided through the external device. That speaker can ultimately inspire an atmosphere in an event hall or various parties and clubs effectively.

The above and other features of the present invention will now be described in detail with reference to certain exemplary embodiments thereof. However, the scope of the present invention is not limited by these embodiments

### FEATURES

100: Main Body
101: Speaker
102: Display unit
103: Communication unit
104: 1st Motor unit
200: Lighting device insertion unit
201: Insertion module (201)
2011: Insert socket (2011)
2012: the 2nd Motor unit
300: Connection unit
301: Supporting structure
3011: Hinge coupling structure
400: Control unit
1000, 2000: External device

1. A light and sound producing speaker comprising:
a main body;
a lighting device insertion unit located at a top of the main body to include at least one insertion part designed to insert lighting devices; and
a connection unit linking the main body and the insertion part,
wherein:
the main body includes:
a speaker that outputs sound source provided from external device,
a display with built-in multiple light sources,
a communication unit that performs wired/wireless communication with external devices and
a first motor unit that provides power for left and right or up and down rotation of the lighting device, and
the insertion part includes:
an insert socket designed to insert lighting devices, and
a second motor unit that provides power for left and right or up and down rotation of the lighting device.

2. The light and sound producing speaker of claim 1, wherein:
the lighting device insertion unit includes a pair of lighting device insertion parts; and
each of the pair of insertion parts has an insert insertion socket having at least one USB type insertion structure.

3. The light and sound producing speaker of claim 1, wherein the connection unit includes a flexible tube

4. The light and sound producing speaker of claim 1, wherein the connection unit includes a supporting structure that is capable of supporting and fixing the lighting device insertion part of the lighting device insertion unit.

5. The light and sound producing speaker of claim 4, wherein the supporting structure includes a hinge coupling structure that supports and fixes the lighting device so that the lighting device can rotate up and down or left and right by the power of the second motor unit.

6. The light and sound producing speaker of claim 1, wherein the display can control the type or genre of sound source provided from external devices and the intensity of the light source, whether the light source blinks, and the blinking interval of the light source according to the operation of a control unit based on a user's mode adjustment provided from external devices

7. The light and sound producing speaker of claim 6, wherein the control unit controls normal mode, lighting mode, sound source playback pattern mode, warning light mode, synchronization mode or mixing mode based on a control signal provided through the communication unit.

8. The light and sound producing speaker of claim 6, wherein the control unit controls:
operation of the first and second motor units based on a user's motion provided through the communication unit, and
operation of a first motor sensor and a second motor sensor based on user's motion information provided from the external device with a motion sensor.
